(19) United States
(12) Patent Application Publication
(10) Pub. No.: US 2002/0044110 A1
(43) Pub. Date: Apr. 18, 2002

(54) Grayscale static pixel cell for oled active matrix display

(76) Inventor: Olivier F. Prache, Pleasantville, NY (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 09/933,419

(22) Filed: Aug. 20, 2001

Related U.S. Application Data
(60) Provisional application No. 60/226,592, filed on Aug. 21, 2000.

(51) Int. Cl. G09G 3/32

(52) U.S. Cl. 345/82

(57) ABSTRACT

The grayscale data for OLED pixels in an active matrix display is stored as digital data in static memory cells of the display. The digital data is provided to current drivers that produce a current level that is proportional to the digital data and deliver grayscale levels to the OLED. The display does not require refreshing and is written to only when the data for pixels has changed.

### CROSS REFERENCE TO RELATED APPLICATIONS

This application claims priority to a provisional application filed Aug. 21, 2000, Serial No. 60/226,592, entitled “GRAY SCALE STATIC PIXEL CELL FOR OLED ACTIVE MATRIX DISPLAY.”

### BACKGROUND OF THE INVENTION

The invention relates to electrical circuits for driving individual elements of an electronic display, and more particularly to providing grayscale data to an Organic Light Emitting Diode (“OLED”) in an OLED display.

OLEDs, which have been known for approximately two decades, are desirable for use in portable micro displays because they combine high levels of luminance and color with small pixel sizes and low power consumption. An active matrix display pixel cell generally employs a capacitor to store data corresponding to the luminance level, or grayscale, which is provided to the associated pixel. The grayscale data is usually stored as an analog signal that corresponds to a charge level in the capacitor. Because of capacitor charge leakage, which is inherent in almost every semiconductor process, the stored charge in each pixel cell is refreshed so as to avoid losing image data or introduce other artifacts to the displayed image, such as flicker. The refreshing operation generally entails reading data from a static memory buffer, such as a computer system's frame buffer, and writing the data to each pixel cell. Reading data from the frame buffer and accessing each pixel in the display consumes resources both on the display unit and the associated image source. Such resources include the display controller which controls access to each pixel cell, the power source from which power is drawn to write the refreshed data, and the processor of the associated image source which manages the frame buffer or other static storage. The drain on resources is especially taxing on portable devices where power supply and space on silicon are at a premium. The need to refresh pixel data is equally true for displays on silicon such as OLED on-silicon or Liquid-Crystal-on-silicon (LcoS), which take advantage of integrated semiconductor devices.

U.S. Pat. No. 5,471,225 discloses a liquid crystal display with an integrated frame buffer where display data corresponding to each liquid crystal cell is stored in static memory. However, the disclosed display does not provide for grayscale capability. Therefore, there is a need for an active matrix display that provides grayscale data and which does not require data refreshing.

### SUMMARY OF THE INVENTION

The present invention provides grayscale data to pixels of a display without requiring refreshing operations. The invention stores the grayscale data in static memory cells that do not require refreshing. The data from the memory cells is used to control current drivers to generate current proportional to the grayscale data stored in the memory cells.

In one embodiment the invention provides for a pixel cell in an active matrix OLED display. The pixel cell includes an OLED, which has an anode and a cathode. The OLED anode is coupled to a common reference line. A current supply line of the pixel cell is coupled to the OLED cathode. The pixel cell also includes a plurality of static cells. Each static cell includes a memory element, which has a bitline input, a power input, a select input, and a data output. The bitline input is coupled to at least one bit of a column data line of the active matrix OLED display. The power input is coupled to a reference voltage source. The select input is coupled to a row select line of the active matrix OLED display. Finally, the static cell includes a current driver, which provides an output current level proportional to the bit position of the column data line bit that is coupled to the bitline input of the memory element. The current driver also has a control input, a supply voltage input, and a current output. The control input is coupled to the data output of the memory element. The supply voltage input is coupled to a supply voltage source. The current output is coupled to the current supply line.

In another embodiment, the invention provides a method for controlling the grayscale current provided to an OLED in an active matrix display. The method stores digital data corresponding to pixel grayscale in a plurality of static memory elements of the display where each element stores at least one data bit. The method provides a plurality of current drivers where each current driver corresponds to a data bit, which is stored in one of the plurality of memory elements. The output current from each current driver is provided to a common current supply line which is coupled to the OLED. Finally, the method delivers each data bit to a control input of the corresponding current driver to control the grayscale current provided to the OLED.

### BRIEF DESCRIPTION OF THE DRAWINGS

FIG. 1 illustrates the logical arrangement of elements of a pixel cell in accordance with the invention;

FIG. 2 illustrates a static memory elements adapted for use in the arrangement of FIG. 1; and

FIG. 3 illustrates a three bit pixel cell implementation of the arrangement in FIG. 1.

### DETAILED DESCRIPTION OF THE INVENTION

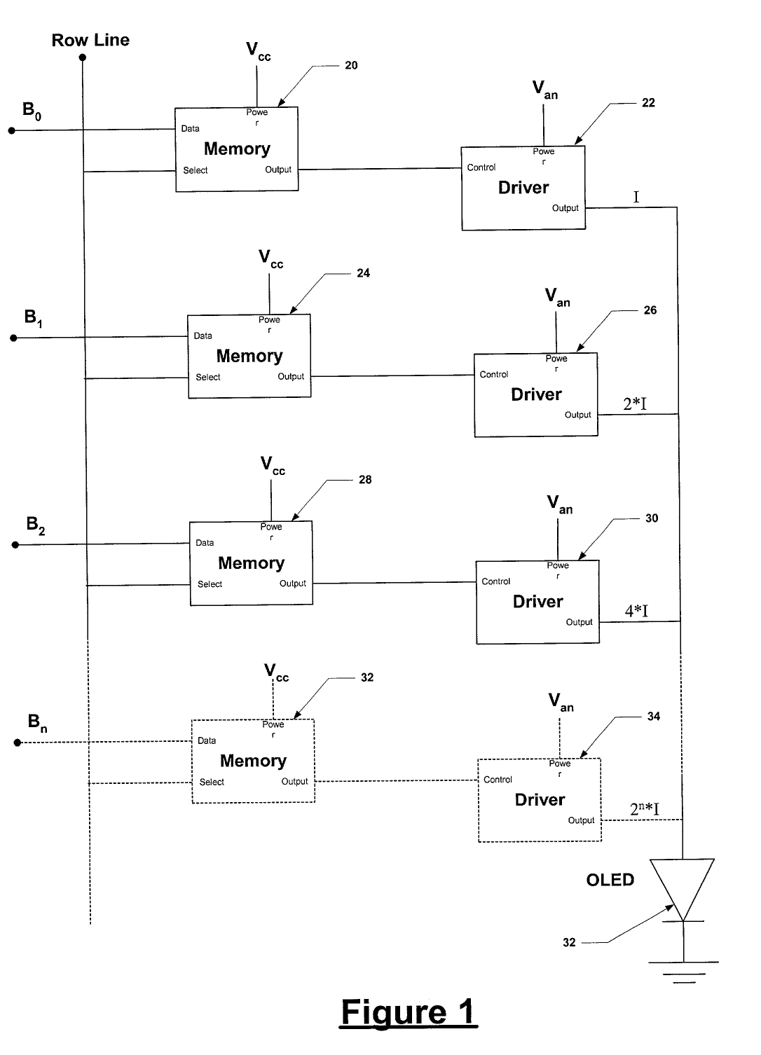

An OLED generally includes a light-emitting layer of a luminescent organic solid and adjacent semiconductor layers that are sandwiched between a cathode and an anode. The cathode and the anode serve as electrodes to conduct current through the organic layers. The current causes electrons to flow to holes in the doped organic materials and thereby produce light. The luminance level, or grayscale, is proportional to the current that is provided to the OLED. Accordingly, several grayscale levels are provided by varying the amount of current that is provided to the OLED. However, as discussed above, storing current levels in capacitors required refreshing, which consumes system resources. The arrangement illustrated in FIG. 1 eliminates refreshing by storing grayscale levels in static memory.

FIG. 1 illustrates the logical components in a pixel cell of the invention. In a matrix-addressed OLED graphics display, individual pixel cells are arranged in a grid pattern. Several pixel cells, forming a column of the grid, preferably share a common data line, generally referred to as a column data line. In a display of the invention, the column data line provides a plurality of data bits as part of a digital indication of pixel grayscale data. In one implementation, the column data line includes a plurality of individual bit lines B0, B1, B2, and Bn, each carry one data bit. In another embodiment, the column data line includes a serial data line, where several bits are provided on the same line and are separated by appropriate hardware, as is known in the art.

Several pixel cells, forming a row of the grid, preferably share a common access line generally referred to as a row access line. The row access line is activated when data is to be written to the associated row. The pixel cells are associated with one or several OLEDs 32, which emit light when current is provided to their cathodes. In some configurations, a group of OLEDs within the matrix forms one pixel cell in a display, with each OLED usually serving as one sub-pixel.

Each pixel cell includes a plurality of memory elements 20, 24, 28, 32 and corresponding current driver pairs 22, 26, 30, 34. Each memory element 20, 24, 28, 32 is preferably a static memory where stored data remains valid as long as power is provided to the memory. Each memory element 20, 24, 28, 32 includes a data input B0, B1, B2, Bn, a select input, a power input, and a data output. The data input is preferably coupled to a bitline B0, B1, B2, Bn, from the column data line of the display. Each bitline corresponds to a bit position of the grayscale data, which is stored in the pixel cell. The select input is preferably coupled to the row line of the display, which corresponds to the matrix row where the pixel cell is located. The power input is coupled to a reference voltage source (Vcc), which provides the operating power to each memory element 20, 24, 28, 32. In one embodiment, the reference voltage Vcc is 3V. The data output is preferably coupled to a control input of an associated current driver 22, 26, 30, or 34.

The data stored in a memory element 20, 24, 28, 32 is written by providing an active signal to the select input while providing the desired data level on the data input. The data is then latched by the memory element 20, 24, 28, 32 and becomes available at the data output after a period of time.

Each current driver 22, 26, 30, 34 includes a control input, a power input, and a current output. The control input is coupled to the memory element data output, as discussed above. The power input is coupled to a supply voltage (Van) which provides the charge source for generating output current by the current source. The current output is coupled to a common current supply line. The current supply line is coupled to the cathode of the pixel cell's OLED 32.

Output current is provided by a current driver 22 when an active signal is provided to its control input. In one embodiment, a current driver 22 provides a predetermined current level in response to an active signal at the control input. When a non-active signal is provided to the control input, substantially no output current is provided to the current supply line. In one embodiment, the predetermined current provided by the current driver 22 is proportional to the bit position of the input bit delivered to the corresponding memory element 20. In one embodiment, the proportional relationship between the predetermined output current and the bit position is a binary number proportion where the relative value of a binary position is weighed according to the base (2) raised to the power of the position. In an embodiment of the invention, the output current to bit position relationship can be expressed by the formula: Iₒᵤₜ=I_{base}*2ⁿ, where Iₒᵤₜ is the predetermined current, I_{base} is the current of the least significant position (B0), and n is the bit position. The current output of each current driver 22, 26, 30, 34 is coupled to a common current supply line of the OLED. Therefore, the current that is delivered to the OLED is the sum of the current delivered by each current driver 22, 26, 30, 34. As may be appreciated, the number of grayscale levels provided by this arrangement is easily increased by adding memory elements and current driver pairs. For example, four such pairs will provide 2⁴, or sixteen, grayscale levels.

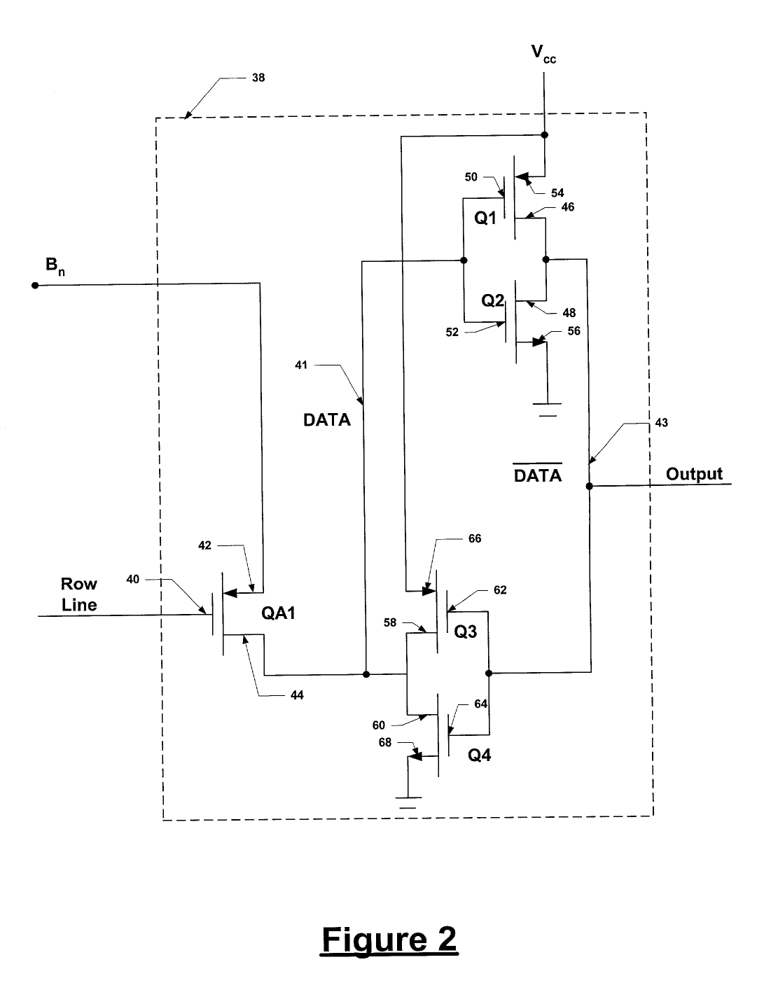

FIG. 2 illustrates a memory element 38 adapted to be used in the arrangement of FIG. 1. The memory element 38 is configured as a pair of cross coupled inverters with an access transistor QA1. The access transistor gate 40 is coupled, as the select input of the memory element 38, to the row line of the display. The access transistor source 42 is coupled, as the data input of the memory element 38, to a bit line of the column data line. The access transistor drain 44 is coupled to the true port 41 of the cross coupled inverter latch. The complement port 43 of the cross coupled inverter latch is coupled, as the data output of the memory element 38, to the control input of the current driver (not shown).

The cross coupled inverter latch is formed from two transistor pairs, each including a P-type MOS transistor and an N-type MOS transistor connected in series. In the first transistor pair Q1, Q2, the P-type transistor drain 46 and the N-type transistor drain 48 are both coupled to one another and to the complement port 43. The P-type transistor gate 50 and the N-type transistor gate 52 are both coupled to one another and to the true port 41. The P-type transistor source 54 is coupled to the reference voltage Vcc. The N-type transistor source 56 is coupled to ground potential.

In the second transistor pair Q3, Q4, the P-type transistor drain 58 and the N-type transistor drain 60 are both coupled to one another and to the true port 41. The P-type transistor gate 62 and the N-type transistor are both coupled to one another and to the complement port 43. The P-type transistor source 66 is coupled to the reference voltage Vcc. The N-type transistor source 68 is coupled to ground potential.

In operation, the row line delivers an active signal (high level for N-type transistor QA1) to the access transistor gate 40 when data is to be written to the memory element 38. The data on the bitline, which is either high level or low level, is provided to the access transistor drain 44 because the access transistor is biased on by the row line. The data from the bitline is provided to the true port 41. The level from the true port is inverted by the first transistor pair inverter Q1, Q2 to provide an inverted level on the complement port 43. The level on the complement port 43 is inverted by the second transistor pair inverter Q3, Q4 to provide the input level back on the true port. When the access transistor is biased off by providing a low signal on the row line, the inverter pair maintains the true and complement signal levels by drawing power from the reference voltage, Vcc. As may be appreciated, in this implementation, the complement level is provided as the output to the current driver. The associated current driver of this implementation is a P-type transistor, which is activated by a low level signal. However, in other embodiments, the true level is provided as the output by coupling the output line to the true port 41 when an N-type transistor is employed as the current driver.

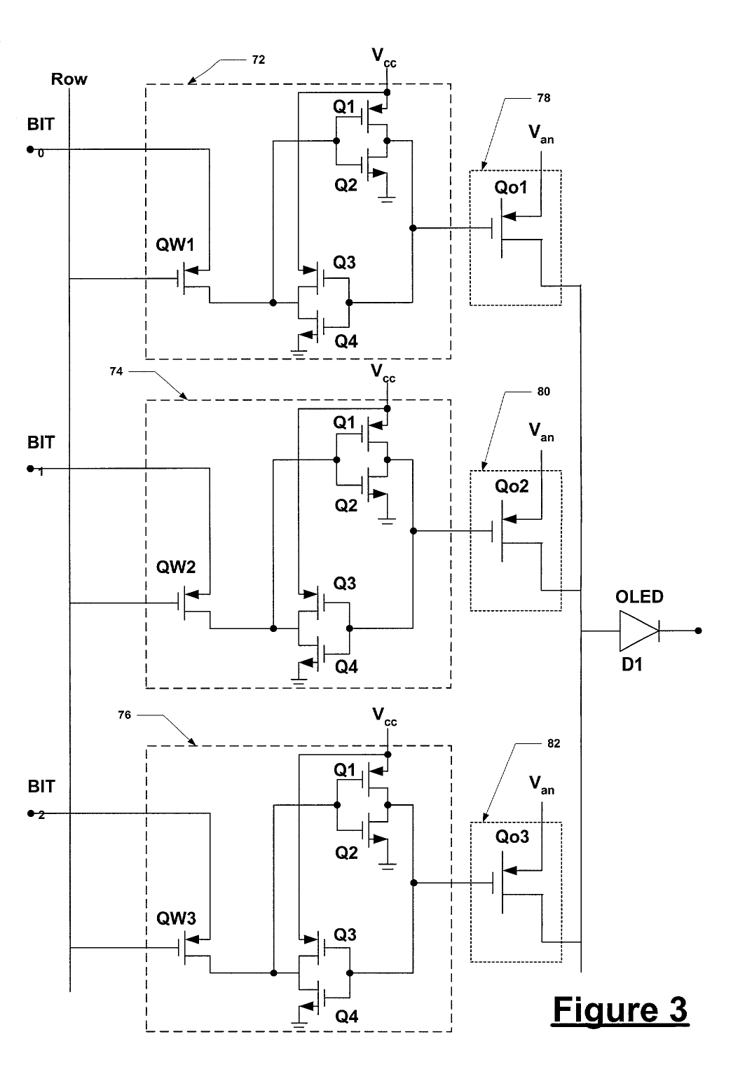

FIG. 3 illustrates an 8 level pixel cell in accordance with the invention. The pixel cell includes three memory element 72, 74, 76 and current driver pairs. Each current driver 78, 80, 82 is a P-type transistor having a source coupled to a supply voltage, a drain coupled to the OLED current supply line, and a gate coupled to the complement port of the cross coupled inverters of each memory element 72, 74, 76. In operation, when the ROW signal is activated, the access transistors (QW1, QW2, and QW3) are turned on, and the bit lines (BIT0, BIT1, and BIT2) are connected to the gates of the first inverter formed by Q1 and Q2. The data (high or low) present on the bit line is then stored in the cell via the cross-coupled inverter pair formed by Q1, Q2, Q3, and Q4. When the ROW signal is deactivated, the inverter pair forms a permanent storage element for as long as the reference voltage Vcc remains applied. The output of each memory element 72, 74, 76 is connected to the gate of each current source (Qo1, Qo2, Qo3). The outputs of the current sources (Qo1, Qo2, Qo3) are tied together and connected to the anode of the OLED device D1 to provide it with the sum of the current flowing through each current source.

By designing the current sources such that Iqo3=2 * Iqo2 and Iqo2=2*Iqo1, up to eight different current values can be reached, which translates into up to 8 light levels at the OLED device. In one embodiment, the relative current output from each current source is controlled by adjusting the transistor's channel Width to Length ratio, as is known in the art. In other embodiments the current output is adjusted by varying other factors, which may be desirable from a space constraint and device-matching standpoint. In one embodiment, the current output is controlled by providing different supply voltages to the current driver transistors to set the operating point of the current drivers and control the produced current.

In other embodiments, the supply voltage is dynamically controlled in an on/off manner during a given period, to control the total amount of light emitter without affecting the maximum number of light levels provided by this circuit.

In one embodiment, the transistors in the pixel cell, making up the ROW access gates and the inverters, can be designed with the minimum design rules, thus maximize the flexibility of the current source design as well as offering the possibility of adding more cells to increase the number of gray levels.

The display of the present invention is preferably implemented as an OLED on silicon microdisplay. In this embodiment, the design takes advantage of the advances in geometries that are achieved by silicon semiconductor processes, such as CMOS, to provide very small individual pixel cells on the silicon. In other embodiments, the display is implemented as a direct view active matrix OLED display using poly or amorphous silicon processes.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A pixel cell in an active matrix OLED display, comprising:
an OLED, the OLED having an anode and a cathode, the anode coupled to a common reference line;
a current supply line, the OLED cathode coupled to the current supply line; and
a plurality of static cells, each static cell comprising:
a memory element, the memory element having a bitline input, a power input, a select input, and a data output, the bitline input coupled to at least one bit of a column data line of the active matrix OLED display, the power input coupled to a reference voltage source, the select input coupled to a row select line of the active matrix OLED display; and
a current driver, the current driver having an output current level proportional to the bit position of the column data line bit coupled to the bitline input of the memory element, the current driver also having a control input, a supply voltage input, and a current output, the control input coupled to the data output of the memory element, the supply voltage input coupled to a supply voltage source, the current output coupled to the current supply line.

2. The pixel cell of claim 1, wherein the output current of the current driver of a static cell is proportional to the bit position of the column data line bit coupled to the bitline input of the memory element as provided by the relationship:
Iₒᵤₜ=I_{base}*2ⁿ
Where:
Iₒᵤₜ is output current of the current driver,
I_{base} is the interval current unit for the grayscale step, and
n is the bit position of the output bit that is provided to the current driver from the memory element.

3. The pixel cell of claim 1, wherein the memory element of each static cell comprises a pair of cross-coupled inverters and an access transistor.

4. The pixel cell of claim 3, wherein the cross-coupled inverters are formed by cross coupled MOS transistor pairs and the access transistor is a MOS transistor.

5. The pixel cell of claim 4, wherein the access transistor drain is coupled to a true port of the cross-coupled inverters and the current driver control input is coupled to a complement port of the cross-coupled inverters.

6. The pixel cell of claim 1, wherein the current driver is a MOS transistor.

7. The pixel cell of claim 6, wherein the current driver is a P-type MOS transistor.

8. A method for controlling the grayscale current provided to an OLED in an active matrix display, comprising:
storing digital data corresponding to pixel grayscale in a plurality of static memory elements of the display, each element storing at least one data bit;
providing a plurality of current drivers, each current driver corresponding to a data bit which is stored in one of said plurality of memory elements, the output current from each current driver provided to a common current supply line which is coupled to the OLED; and
delivering each data bit to a control input of the corresponding current driver to control the grayscale current provided to the OLED.

9. A pixel cell for use in an active matrix display, comprising:
a plurality of static memory elements, each having a data input, a select input, a power input, and a control signal output for supplying first and second control signals for activating and deactivating a current driver, respectively; and
current drivers associated with said memory element, wherein each current driver has an output connected to a common signal line, a control signal input connected to the control signal output of its associated memory element, and a power input, wherein said current drivers include a first current driver and a second current driver, the first current driver, responsive to receiving a first control signal, outputs a first predetermined current, and the second current driver, responsive to receiving a first control signal, outputs a second predetermined current which is different from said first predetermined current.

10. A pixel cell according to claim 9, wherein a third current driver, responsive to receiving a first control signal, outputs a third predetermined current which is different from said first and second predetermined currents.

11. The pixel cell of claim 9, wherein the predetermined current of each current driver is proportional to the bit position of a column data line bit coupled to the data input of an associated memory element as provided by the relationship:
Iₒᵤₜ=I_{base}*2ⁿ
Where:
Iₒᵤₜ is the predetermined current of the current driver,
I_{base} is the interval current unit for the grayscale step, and
n is the bit position of the control signal output that is provided to the current driver from the associated memory element.

12. The pixel cell of claim 9, wherein the memory element comprises a pair of cross-coupled inverters and an access transistor.

13. The pixel cell of claim 12, wherein the cross-coupled inverters are formed by cross coupled MOS transistor pairs and the access transistor is a MOS transistor.

14. The pixel cell of claim 13, wherein the access transistor drain is coupled to a true port of the cross-coupled inverters and the current driver control input is coupled to a complement port of the cross-coupled inverters.

15. The pixel cell of claim 9, wherein each current driver is a MOS transistor.

16. The pixel cell of claim 15, wherein each current driver is a P-type MOS transistor.
